(19) United States
(12) Patent Application Publication
(10) Pub. No.: US 2017/0116521 A1
(43) Pub. Date: Apr. 27, 2017

(54) TAG PROCESSING METHOD AND DEVICE

(71) Applicant: BEIJING BAIDU NETCOM SCIENCE AND TECHNOLOGY CO., LTD., Beijing (CN)

(72) Inventors: Jiang WANG, Beijing (CN); Chang HUANG, Beijing (CN)

(73) Assignee: BEIJING BAIDU NETCOM SCIENCE AND TECHNOLOGY CO., LTD., Beijing (CN)

(21) Appl. No.: 15/273,551

(22) Filed: Sep. 22, 2016

(30) Foreign Application Priority Data
Oct. 27, 2015 (CN) 201510707963.X

(51) Int. Cl. G06N 3/08; G06F 17/30; G06F 7/08; G06N 3/04; G06N 7/00

(52) U.S. Cl. CPC G06N 3/08; G06N 3/04; G06N 7/005; G06F 7/08; G06F 17/3089

(57) ABSTRACT

The present invention provides a tag processing method and device. In the embodiments of the present invention, through obtaining semantic characteristic data of a resource and then obtaining posterior probabilities of at least one tag sequence of the resource according to the semantic characteristic data of the resource, it is possible to select, based on the posterior probabilities, a tag sequence as a tag set for the resource, and thus realize the purpose of obtaining a plurality of tags for the resource.

This application claims the priority of the Chinese patent application filed on Oct. 27, 2015 with the application No. 201510707963X and the title “Tag processing method and device”

### TECHNICAL FIELD

The present invention relates to tag processing technology, and more particularly to a tag processing method and device.

### BACKGROUND

Social tagging, referred to as tagging, is a more flexible and more interesting way of classification, which allows a user to freely tag all kinds of resources, such as web pages, academic papers, and multimedia. Social tagging can help a user to sort and query information of all kinds. It is widely used in social bookmarking web sites (for example, Flickr, Picassa, YouTube, Plaxo, etc.), blogs (e.g., Blogger, WordPress, LiveJournal, etc.), encyclopedias (example, Wikipedia, PBWiki etc.), microbloggings (for example, Twitter, Jaiku, etc.), and other systems. The prior art provides a single tag classification method to generate one tag for a resource.

Nevertheless, due to the complexity of objective things, a resource may have several different tags. Nowadays, it is a hot topic to multi-tag a resources in order to generate a plurality of tags for the resource.

### SUMMARY

Aspects of the present invention provide a tag processing method and device to obtain a plurality of tags for a resource.

One aspect of the present invention provides a tag processing method, comprising:

obtaining semantic characteristic data of a resource;

obtaining posterior probabilities of at least one tag sequence of the resource according to the semantic characteristic data of the resource;

selecting, based on the posterior probabilities, one tag sequence as a tag set for the resource.

As the aspect described above and in any possible way of implementation, one way of implementation is further provided, in which the step of obtaining semantic characteristic data of a resource comprises:

using a pre-built convolutional neural network to process the resource to obtain the semantic characteristic data of the resource.

As the aspect described above and in any possible way of implementation, one way of implementation is further provided, in which the method further comprises:

sorting at least one tag contained in each first training sample in a first training sample set based on the occurrences of tags in the first training sample set, so as to obtain a sample sequence of each first training sample;

constructing the convolutional neural network based on the sample sequence of each first training sample.

As the aspect described above and in any possible way of implementation, one way of implementation is further provided, in which step of obtaining posterior probabilities of at least one tag sequence of the resource according to the semantic characteristic data of the resource comprises:

obtaining posterior probabilities of at least one tag sequence of the resource according to the semantic characteristic data of the resource using a pre-built recurrent neural network.

As the aspect described above and in any possible way of implementation, one way of implementation is further provided, in which the method further comprises:

sorting at least one tag contained in each second training sample in a second training sample set based on the occurrences of tags in the second training sample set, so as to obtain a sample sequence of each second training sample;

obtaining semantic characteristic data of one resource included in each second training sample in the second training sample set;

constructing the recurrent neural work based on the sample sequence of each second training sample and the semantic characteristic data of one resource included in each second training sample.

As the aspect described above and in any possible way of implementation, one way of implementation is further provided, in which the step of selecting, based on the posterior probabilities, one tag sequence as a tag set for the resource comprise:

selecting the tag sequence based on the posterior probabilities, from all of the tag sequences of the resource; or

selecting the tag sequence based the posterior probabilities, from a portion of the tag sequence of a resource.

As the aspect described above and in any possible way of implementation, one way of implementation is further provided, in which the resources include images.

Another aspect of the present invention provides a tag processing device, wherein the device comprises:

an acquisition unit for obtaining semantic characteristic data of a resource;

a processing unit for obtaining posterior probabilities of at least one tag sequence of the resource based on the semantic characteristic data of the resource; and

a selecting unit for selecting one tag sequence as a tag set of the resource based on the posterior probabilities.

As the aspect described above and in any possible way of implementation, one way of implementation is further provided, in which the acquisition unit is specifically used for:

using a pre-built convolutional neural network to process the resource to obtain the semantic characteristic data of the resource.

As the aspect described above and in any possible way of implementation, one way of implementation is further provided, in which the acquisition unit is further used for:

sorting at least one tag contained in each first training sample in a first training sample set based on the occurrences of tags in the first training sample set, so as to obtain a sample sequence of each first training sample;

constructing the convolutional neural network based on the sample sequence of each first training sample.

As the aspect described above and in any possible way of implementation, one way of implementation is further provided, in which the processing unit is specifically used for:

obtaining posterior probabilities of at least one tag sequence of the resource according to the semantic characteristic data of the resource using a pre-built recurrent neural network.

As the aspect described above and in any possible way of implementation, one way of implementation is further provided, in which the processing unit is further used for:

sorting at least one tag contained in each second training sample in a second training sample set based on the occurrences of tags in the second training sample set, so as to obtain a sample sequence of each second training sample;

obtaining semantic characteristic data of one resource included in each second training sample in the second training sample set;

constructing the recurrent neural work based on the sample sequence of each second training sample and the semantic characteristic data of one resource included in each second training sample.

As the aspect described above and in any possible way of implementation, one way of implementation is further provided, in which the selecting unit is specifically used for:

selecting the tag sequence based on the posterior probabilities, from all of the tag sequences of the resource; or

selecting the tag sequence based the posterior probabilities, from a portion of the tag sequence of a resource.

As the aspect described above and in any possible way of implementation, one way of implementation is further provided, in which the resources include images.

Another aspect of the present invention provides an apparatus, comprising: one or more processors;

a memory;

one or more programs, which are stored in the memory, and execute the following when executed by the one or more processors:

obtaining semantic characteristic data of a resource;

obtaining posterior probabilities of at least one tag sequence of the resource according to the semantic characteristic data of the resource;

selecting, based on the posterior probabilities, one tag sequence as a tag set for the resource.

Another aspect of the present invention provides a nonvolatile computer storage medium, stored with one or more programs, which, when executed by an apparatus, makes the apparatus to execute the following:

obtaining semantic characteristic data of a resource;

obtaining posterior probabilities of at least one tag sequence of the resource according to the semantic characteristic data of the resource;

selecting, based on the posterior probabilities, one tag sequence as a tag set for the resource.

As can be seen from the above, in the embodiments of the present invention, through obtaining semantic characteristic data of a resource and then obtaining posterior probabilities of at least one tag sequence of the resource according to the semantic characteristic data of the resource, it is possible to select, based on the posterior probabilities, a tag sequence as a tag set for the resource, and thus realize the purpose of obtaining a plurality of tags for the resource.

In addition, due to the consideration of the relationships between respective tags of the tag sequence, for example, correlation, co-linearity, etc., the technical solution of the present invention makes it possible to obtain a tag sequence of the resource, instead of using the method of single-tag classification to individually obtain a plurality of independent tags of the resource, which can improve the reliability of obtaining tags of a resource.

In addition, through using the convolutional neural network, the technical solution of the present invention makes it possible to obtain more accurate semantic characteristic data of a resource, it is therefore possible to effectively improve the reliability of obtaining semantic characteristic data of a resource.

In addition, through using recurrent neural network, the technical solution of the invention makes it possible to represent the relationships between respective tags in a tag sequence, for example, correlation, and co-linearity, etc., it is therefore possible to effectively improve the reliability of obtaining semantic characteristic data of a resource.

In addition, through constructing a recurrent neural network, the technical solution of the present invention makes it possible to quickly learn the association relationships between respective tags in a tag sequence, for example, correlation, co-linearity, etc., it is therefore possible to effectively improve the efficiency of learning association relationships of a tag sequence.

### BRIEF DESCRIPTION OF DRAWINGS

In order to more clearly illustrate the technical solutions in the embodiments of the present invention, the drawings used for description of the embodiments or prior art will be briefly described; as is obvious, the drawings described below refer to some embodiments of the invention, those of ordinary skills can, without creative efforts, also obtain other drawings based on these drawings.

FIG. 1 is a schematic flowchart of the tag processing method of one embodiment of the invention;

FIG. 2 is a schematic flowchart of the tag processing device of another embodiment of the invention;

### DETAILED DESCRIPTION

To show the object, technical solutions, and advantages of the embodiments of the invention more clearly, the technical solutions of the embodiments of the present invention will be described fully and clearly below in conjunction with the drawings of the embodiment of the invention. It is clear that the described embodiments are only part, not all, of the embodiments of the present invention. Based on the embodiments of the present invention, all other embodiments made by one of ordinary skills in the art without creative labor are within the protection scope of the present invention.

It should be noted that terminals involved in the embodiments of the present invention may include, but are not limited to, cell phones, personal digital assistants (PDA), wireless handheld devices, tablet computers, personal computers (PC), MP3 players, MP4 players, wearable devices (for example, smart glasses, smart watches, smart bracelet, etc.).

In addition, the term “and/or” is merely description of the associated relationship of associated objects, indicating that three kinds of relationship can exist, for example, A and/or B, can be expressed as: the presence of A alone, presence of both A and B, presence of B alone. In addition, the character “/” generally represents an “OR” relationship between the associated objects before and after the character.

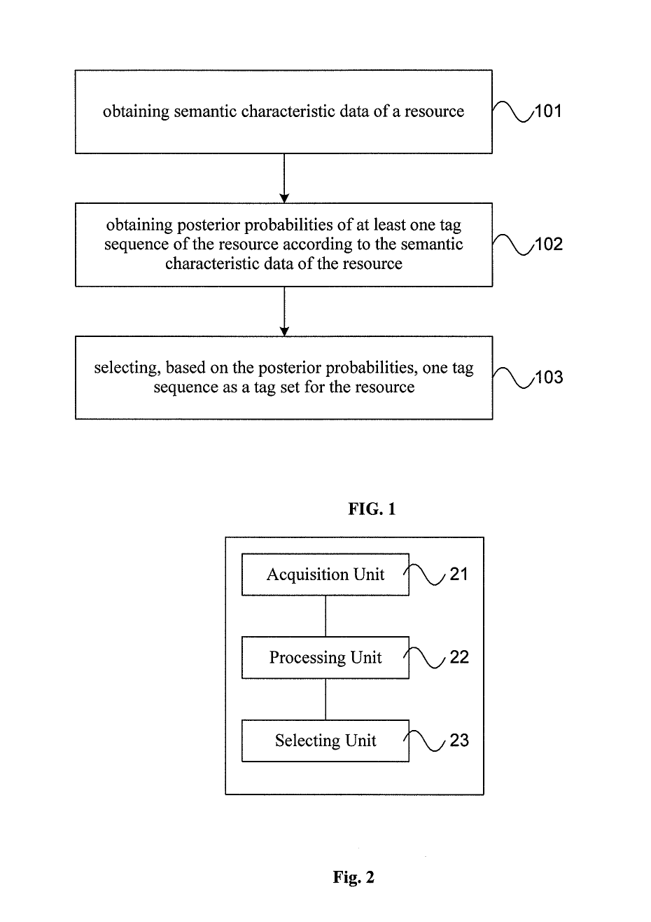

FIG. 1 is a schematic flow diagram of the tag processing method of an embodiment of the invention, as shown in FIG. 1.

101, obtaining semantic characteristic data of a resource.

102, obtaining posterior probabilities of at least one tag sequence of the resource according to the semantic characteristic data of the resource.

103, selecting, based on the posterior probabilities, one tag sequence as a tag set for the resource.

It should be noted that part or all of the executive agent of 101 to 103 can be an App (application) located in a local terminal, a functional unit such as a plug-in or software development kit (SDK) disposed in an App located in a local terminal, a processing engine in a network server, or a distributed system in a network. The present embodiment is not particularly limited to the aforementioned.

As can be understood, the App can be a native App installed locally in a terminal, or a web App of a browser in a terminal. The present embodiment is not particularly limited.

In this way, through obtaining semantic characteristic data of a resource and then obtaining posterior probabilities of at least one tag sequence of the resource based on the semantic characteristic data of the resource, it is possible to select, based on the posterior probabilities, one tag sequence as the tag set of the resource, realizing the purpose of obtaining a plurality of tags of for the resource.

The resource involved in the present embodiment may refer to a resource of network information, which is the sum of various resources of information that can be used in a computer network. Specifically, it may be any resource in which texts, images, sound, animation and other forms of information are stored in the form of electronic form in non-paper media such as optical and magnetic media and can be reproduced via network communication, a computer, or a terminal, etc.

In a preferred implementation, the resource may be images. The so-called image may refer to files formed via storing image data, i.e. pixels of the image, with a certain image format in a certain manner, it can also be called image file.

Herein, the image format of an image, namely the image storage format, may include, but are not limited to, bitmap (BMP) format, Portable Network Graphic (PNG) format, Joint Photographic Experts Group (JPEG) format, and Exchangeable Image File (EXIF) format. This embodiment is not particularly limited.

Alternatively, in a possible implementation of the embodiment, at 101, it is specifically possible to use a pre-built convolutional neural network to process the resource to obtain the semantic characteristic data of the resource.

In a particular implementation, it is possible to further build, in advance, a convolutional neural network. Specifically, one can sort at least one tag contained in each first training sample in a first training sample set based on the occurrences of tags in the first training sample set, so as to obtain a sample sequence of each first training sample. Next, one can build the convolutional neural network based on the sample sequence of each first training sample. The convolutional neural network can effectively represent the mapping from the resource to the semantic characteristic data.

The so-called neural network is a feed-forward neural network using convolution, it can effectively simulate the image understanding process in a human brain, and thus highly suitable for image processing and understanding.

For example, specifically, it is possible to sort at least one tag contained in each first training sample in a first training sample set based on a descending order of the numbers of occurrences of tags in the first training sample set, so as to obtain a sample sequence of each first training sample.

Alternatively, specifically, one can sort at least one tag contained in each first training sample in a first training sample set based on the times of occurrences of tags in the first training sample set in an order from the time nearest to the current time to the time farthest to the current time, so as to obtain a sample sequence of each first training sample.

It should be noted that first training samples contained in each first training set can be a known samples that have been already tagged, i.e., a resource tagged with tags, so that it is possible to use the known samples for training to build a target convolutional neural network. Or, a portion of the first training samples are tagged know samples, while another portion are untagged unknown samples; in this case, the known samples can be used for training to build an initial convolutional neural network, which is then used to predict the unknown samples so as to obtain a tag classification result, the tag classification result of the unknown samples is then used to tag the unknown samples so as to form known samples as newly added known samples, which, as well as the original known samples, are used for re-training, so as to obtain a new convolutional neural network, until the built convolutional neural network or the known samples meet the cut-off condition of the target convolutional neural network. The cut-off condition can be, for example, the accuracy of the classification is greater than or equal to a preset threshold value, or the number of known samples is greater than or equal to a preset threshold number.

In addition, besides the above-mentioned convolutional neural network, one can also use a variety of image features designed manually to obtain the semantic characteristic data of a resource, for example, Scale-Invariant Feature Transform (SIFT), Histogram of Oriented gradients (HOG). Compared with the convolutional neural network, such a method has drawbacks as follows:

The process is completely manually designed, which, in actual practice, requires careful adjustment of relevant parameters;

During image processing, a large amount of image information is lost.

Accordingly, with a convolutional neural network, it is possible to obtain more accurate semantic characteristic data of a resource; it is therefore possible to improve the reliability of obtaining semantic characteristic data of a resource.

Alternatively, in a possible implementation of this embodiment, in 102, specifically, it is possible to obtain posterior probabilities of at least one tag sequence of a resource according to the semantic characteristic data of the resource using a pre-built recurrent neural network.

The so-called posterior probability of a tag sequence can be the probability that is re-corrected after obtaining the information of the result (i.e., the image and the tag sequence of the image) after re-correction.

In one particular implementation, it is further possible to build, in advance, a recurrent neural network. One can sort at least one tag contained in each second training sample in a second training sample set based on the occurrences of tags in the second training sample set, so as to obtain a sample sequence of each second training sample. And one can obtain semantic characteristic data of one resource included in each second training sample in the second training sample set. Then, one can construct the recurrent neural work based on the sample sequence of each second training sample and semantic characteristic data of one resource included in each second training sample. The recurrent neural network can effectively represent the mapping of the relationship from the semantic characteristic data to the tag sequence.

The so-called recurrent neural network is a neural network having a loop, it can show the dynamic characteristics of a time series by updating its internal state, and can handle a sequence of any length. It is therefore highly suited for modeling the relationship among various elements of data of sequence (such as the tag sequence in the present invention), for example, natural speech, voice, handwriting recognition, etc.

Here, the second training sample set used for construction of recurrent neural network and the first training sample set previously used for construction of convolutional neural network may be the same training sample set, or may be two different training sample sets. The present embodiment is not particularly limited.

It should be noted that the second training samples included in each second training sample set can be known samples, i.e., resource tagged with tags, so that one can directly use these known samples for training, so as to build the target convolutional neural network; or part of them can be known samples tagged with tags, and another part are unknown samples that are not tagged, in this way, one can use the known sample for training, in order to build the initial convolutional neural network, and then use the initial convolutional neural network to predict unknown samples, to obtain the tag classification result, and then one can tag the unknown samples based on the tag classification result of the unknown samples, to form known samples as newly added known samples, and one can use the newly added known samples, as well as the original known samples, to do re-training in order to build a new convolutional neural network, until the built convolutional neural network or known samples meet the cut-off condition of the target convolutional neural network, such as, the classification accuracy being equal to or greater than a preset threshold value, or the number of known samples being equal to or greater than a preset threshold number, etc. The present embodiment is not particularly limited.

In addition, besides the above-mentioned convolutional neural network, one can also use other methods to carry out study on the relationships between respective tags in a tag sequence, for example, correlation, co-linearity, etc. The methods for example are conditional random field model, Markov field model, and other model-based methods. These methods can only represent associated relationships between two tags, and the operation speed in the learning process is slow. For another example, the method can be one combining a plurality of tags into one tag, etc. This method has quite complicated learning process, large calculation, and low speed.

Thus, with recurrent neural network, one can represent the relationships among respective tags in a tag sequence, for example, correlation, and co-linearity shown, it is therefore possible to improve the reliability of obtaining tags of a resource.

In addition, by constructing a recurrent neural network, one can have low computation work in the learning process, making it possible to quickly learn the relationships between respective tags in a tag sequence, for example, correlation, co-linearity, etc., it is therefore possible to improve the efficiency of learning association relationships in a tag sequence.

Alternatively, in a possible implementation of this embodiment, at 103, specifically, one can select the tag sequence with the maximum posterior probability as said one tag sequence according to the posterior probabilities, from all of the tag sequences of the resource.

Alternatively, in a possible implementation of this embodiment, at 103, specifically, one can select the tag sequence with the maximum posterior probability as said one tag sequence according to the posterior probabilities, from a portion of the tag sequence of a resource.

In one particular implementation, one may further set a probability threshold in advance. In all the obtained tag sequences of the resource, one may use the probability threshold, to filter out all the tag sequences with the posterior probabilities less than the probability threshold value, and select, in the left tag sequences, the tag sequence with the maximum posterior probability, as said one tag sequence.

In the present embodiment, through obtaining semantic characteristic data of the resource and then obtaining posterior probabilities of at least one tag sequence based on the semantic characteristic data of the resource, it is possible to select, based on the posterior probabilities, one tag sequence as a tag set of the resource, and thus achieve the purpose of obtaining a plurality of tags of the resource.

In addition, due to the consideration of the relationships between respective tags of the tag sequence, for example, correlation, co-linearity, etc., the technical solution of the present invention makes it possible to obtain a tag sequence of the resource, instead of using the method of single-tag classification to individually obtain a plurality of independent tags of the resource, which can improve the reliability of obtaining tags of a resource.

In addition, through using the convolutional neural network, the technical solution of the present invention makes it possible to obtain more accurate semantic characteristic data of a resource, it is therefore possible to effectively improve the reliability of obtaining semantic characteristic data of a resource.

In addition, through using recurrent neural network, the technical solution of the invention makes it possible to represent the relationships between respective tags in a tag sequence, for example, correlation, and co-linearity, etc., it is therefore possible to effectively improve the reliability of obtaining tags of a resource.

In addition, through constructing a recurrent neural network, the technical solution of the present invention makes it possible to quickly learn the association relationships between respective tags in a tag sequence, for example, correlation, co-linearity, etc., it is therefore possible to effectively improve the efficiency of learning association relationships of a tag sequence.

As should be noted, for the sake of simple description, each of the aforementioned embodiments of the method is described as a combination of a series of actions. Those skilled in the art, however, should be aware that the present invention is not limited to the orders of actions as described, because according to the present invention, some steps may employ other sequences or be carried out simultaneously. Secondly, those skilled in the art will also be aware that the embodiments described in the specification belong to preferred embodiments, the involved actions and modules are not necessarily a must for the present invention.

In the above embodiments, the descriptions of the various embodiments have different emphases, a part not included in a certain embodiment can be found in other described embodiments.

FIG. 2 is a schematic diagram of tag processing device according to another embodiment of the present invention, as shown in FIG. 2. The tag processing device of the present embodiment may include: an acquisition unit 21, a processing unit 22, and a selecting unit 23. Herein, the acquisition unit 21 is used for obtaining semantic characteristic data of a resource; the processing unit 22 is used for obtaining posterior probabilities of at least one tag sequence of the resource based on the semantic characteristic data of the resource; and the selecting unit 23 is used for selecting one tag sequence as a tag set of the resource based on the posterior probabilities.

It should be noted that a part of or the entire tag processing device of the present embodiment can be an App located in a local terminal, a functional unit such as a plug-in or software development kit (SDK) disposed in an App located in a local terminal, a processing engine in a network server, or a distributed system in a network, the present embodiment is not particularly limited.

As can be understood, the App can be a native App installed locally in a terminal, or it can also be a web App of a browser in a terminal. The present embodiment is not particularly limited.

The resource involved in the present embodiment may refer to a resource of network information, which is the sum of various resources of information that can be used in a computer network. Specifically, it may be any resource in which texts, images, sound, animation and other forms of information are stored in the form of electronic form in non-paper media such as optical and magnetic media and can be reproduced via network communication, a computer, or a terminal, etc.

In a preferred implementation, the resource may be images. The so-called image may refer to files formed via storing image data, i.e. pixels of the image, with a certain image format in a certain manner, it can also be called image file.

Alternatively, in a possible implementation of the embodiment, the acquisition unit 21 may specifically use a pre-built convolutional neural network to process the resource to obtain semantic characteristic data of a resource.

In a particular implementation, the acquisition unit 21 can be further used to sort at least one tag contained in each first training sample in a first training sample set based on the occurrences of tags in the first training sample set, so as to obtain a sample sequence of each first training sample and build the convolutional neural network based on the sample sequence of each first training sample.

Alternatively, in a possible implementation of this embodiment, the process unit 22 can be specifically used to obtain posterior probabilities of at least one tag sequence of the resource according to the semantic characteristic data of the resource using a pre-built recurrent neural network.

In one particular implementation, the processing unit 22 can be further used for: sorting at least one tag contained in each second training sample in a second training sample set based on the occurrences of tags in the second training sample set, so as to obtain a sample sequence of each second training sample; obtaining semantic characteristic data of one resource included in each second training sample in the second training sample set; and constructing the recurrent neural work based on the sample sequence of each second training sample and semantic characteristic data of one resource included in each second training sample

Alternatively, in a possible implementation of this embodiment, the selecting unit 23 can be specifically used to select the tag sequence with the maximum posterior probability as said one tag sequence according to the posterior probabilities, from all of the tag sequences of the resource.

Alternatively, in a possible implementation of this embodiment, the selecting unit 23 can be specifically used to select the tag sequence with the maximum posterior probability as said one tag sequence according to the posterior probabilities, from a part of the tag sequences of the resource.

As should be noted, in the method of the embodiment of FIG. 1 can be implemented by the tag processing device provided in this embodiment. Detailed description can be found in related resources with references to FIG. 1, whose description will not be repeated here.

In the present embodiment, through obtaining semantic characteristic data of the resource and then obtaining posterior probabilities of at least one tag sequence based on the semantic characteristic data of the resource, it is possible to select, based on the posterior probabilities, one tag sequence as the tag set of the resource, and thus achieve the purpose of obtaining a plurality of tags of the resource.

In addition, due to the consideration of the relationships between respective tags of the tag sequence, for example, correlation, co-linearity, etc., the technical solution of the present invention makes it possible to obtain a tag sequence of the resource, instead of using the method of single-tag classification to individually obtain a plurality of independent tags of the resource, which can improve the reliability of obtaining tags of a resource.

In addition, through using the convolutional neural network, the technical solution of the present invention makes it possible to obtain more accurate semantic characteristic data of the resource, it is therefore possible to effectively improve the reliability of obtaining semantic characteristic data of a resource.

In addition, through using recurrent neural network, the technical solution of the invention makes it possible to represent the relationships between respective tags in the tag sequence, for example, correlation, and co-linearity, etc., it is therefore possible to effectively improve the reliability of obtaining tags of a resource.

In addition, through constructing a recurrent neural network, the technical solution of the present invention makes it possible to quickly learn the association relationships between respective tags in the tag sequence, for example, correlation, co-linearity, etc., it is therefore possible to effectively improve the efficiency of learning association relationships of the tag sequence.

Those skilled in the art can clearly understand that, for convenience and simplicity of description, the specific working processes of the aforementioned systems, devices, and units can be understood with references to the corresponding processes of the above embodiments, whose detailed description will not be repeated here.

As should be understood, in the various embodiments of the present invention, the disclosed systems, devices, and methods can be implemented through other ways. For example, the embodiments of the devices described above are merely illustrative. For example, the division of the units is only a logical functional division, the division may be done in other ways in actual implementations, for example, a plurality of units or components may be combined or be integrated into another system, or some features may be ignored or not implemented. Additionally, the displayed or discussed coupling or direct coupling or communicating connection between one and another may be indirect coupling or communicating connection through some interface, device, or unit, which can be electrical, mechanical, or of any other forms.

The units described as separate members may be or may be not physically separated, the components shown as units may or may not be physical units, which can be located in one place, or distributed in a number of network units. One can select some or all of the units to achieve the purpose of the embodiments according to the embodiment of the actual needs.

Further, in the embodiment of the present invention, the functional units in each embodiment may be integrated in a processing unit, or each unit may be a separate physical existence, or two or more units can be integrated in one unit. The integrated units described above can be used both in the form of hardware, or in the form of software plus hardware.

The aforementioned integrated unit implemented in the form of software may be stored in a computer readable storage medium. Said functional units of software are stored in a storage medium, including a number of instructions to instruct a computer device (it may be a personal computer, server, or network equipment, etc.) or processor to perform some steps of the method described in various embodiments of the present invention. The aforementioned storage medium includes: U disk, removable hard disk, read-only memory (ROM), a random access memory (RAM), magnetic disk, or an optical disk medium may store program code.

Finally, as should be noted, the above embodiments are merely provided for describing the technical solutions of the present invention, not intended to limit them; although references to the embodiments of the present invention have been made to describe the details of the present invention, those skilled in the art will appreciate: one can still make changes on the technical solutions described in the various embodiments, or make equivalent replacements to some technical features; and such modifications or replacements do not make the essence of corresponding technical solutions depart from the spirit and scope of embodiments of the present invention.

We claim:

1. A tag processing method, wherein the method comprises:
obtaining semantic characteristic data of a resource;
obtaining posterior probabilities of at least one tag sequence of the resource according to the semantic characteristic data of the resource;
selecting, based on the posterior probabilities, one tag sequence as a tag set for the resource.

2. The method according to claim 1, wherein the step of obtaining semantic characteristic data of a resource comprises:
using a pre-constructed convolutional neural network to process the resource, so as to obtain the semantic characteristic data of the resource.

3. The method according to claim 2, wherein the method further comprises:
sorting at least one tag contained in each first training sample in a first training sample set based on the occurrences of tags in the first training sample set, so as to obtain a sample sequence of each first training sample;
constructing the convolutional neural network based on the sample sequence of each first training sample.

4. The method according to claim 1, wherein the step of obtaining posterior probabilities of at least one tag sequence of the resource according to the semantic characteristic data of the resource comprises:
obtaining posterior probabilities of at least one tag sequence of the resource according to the semantic characteristic data of the resource using a pre-constructed recurrent neural network.

5. The method according to claim 4, wherein the method further comprises:
sorting at least one tag contained in each second training sample in a second training sample set based on the occurrences of tags in the second training sample set, so as to obtain a sample sequence of each second training sample;
obtaining semantic characteristic data of one resource included in each second training sample in the second training sample set;
constructing the recurrent neural work based on the sample sequence of each second training sample and the semantic characteristic data of one resource included in each second training sample.

6. The method according to claim 1, wherein the step of selecting, based on the posterior probabilities, one tag sequence as a tag set for the resource comprise:
selecting the tag sequence based on the posterior probabilities, from all of the tag sequences of the resource; or
selecting the tag sequence based the posterior probabilities, from a portion of the tag sequence of a resource.

7. The method according to claim 1, wherein the resources include images.

8. A device for tag processing, comprising:
at least one processor; and
a memory storing instructions, which when executed by the at least one processor, cause the at least one processor to perform operations, the operations comprising:
obtaining semantic characteristic data of a resource;
obtaining posterior probabilities of at least one tag sequence of the resource according to the semantic characteristic data of the resource;
selecting, based on the posterior probabilities, one tag sequence as a tag set for the resource.

9. The device according to claim 8, wherein the operations of obtaining semantic characteristic data of a resource comprises:
using a pre-constructed convolutional neural network to process the resource, so as to obtain the semantic characteristic data of the resource.

10. The device according to claim 9, wherein the operations further comprises:
sorting at least one tag contained in each first training sample in a first training sample set based on the occurrences of tags in the first training sample set, so as to obtain a sample sequence of each first training sample;
constructing the convolutional neural network based on the sample sequence of each first training sample.

11. The device according to claim 8, wherein the operations of obtaining posterior probabilities of at least one tag sequence of the resource according to the semantic characteristic data of the resource comprises:
obtaining posterior probabilities of at least one tag sequence of the resource according to the semantic characteristic data of the resource using a pre-constructed recurrent neural network.

12. The device according to claim 11, wherein the operations further comprises:
sorting at least one tag contained in each second training sample in a second training sample set based on the occurrences of tags in the second training sample set, so as to obtain a sample sequence of each second training sample;
obtaining semantic characteristic data of one resource included in each second training sample in the second training sample set;
constructing the recurrent neural work based on the sample sequence of each second training sample and the semantic characteristic data of one resource included in each second training sample.

13. The device according to claim 8, wherein the operations of selecting, based on the posterior probabilities, one tag sequence as a tag set for the resource comprise:
selecting the tag sequence based on the posterior probabilities, from all of the tag sequences of the resource; or
selecting the tag sequence based the posterior probabilities, from a portion of the tag sequence of a resource.

14. The device according to claim 8, wherein the resources include images.

15. A nonvolatile computer storage medium, stored with one or more programs, which, when executed by an apparatus, make the apparatus to execute the following:
obtaining semantic characteristic data of a resource;
obtaining posterior probabilities of at least one tag sequence of the resource according to the semantic characteristic data of the resource;
selecting, based on the posterior probabilities, one tag sequence as a tag set for the resource.
